(19) United States
(12) Patent Application Publication
(10) Pub. No.: US 2009/0083941 A1
(43) Pub. Date: Apr. 2, 2009

(54) HINGE STRUCTURE WITH FLEXIBLE SOCKET PORTION

(75) Inventor: LIN-KAI HUNG, Taipei County (TW)

Correspondence Address: ROSENBERG, KLEIN & LEE, 3458 ELLICOTT CENTER DRIVE-SUITE 101, ELLICOTT CITY, MD, 21043, US

(73) Assignee: PROTORSION HINGE CO., LTD., Taipei County (TW)

(21) Appl. No.: 11/939,828

(22) Filed: Nov. 14, 2007

(30) Foreign Application Priority Data
Sep. 29, 2007 (TW) 096216270

(51) Int. Cl. E05D 7/10

(52) U.S. Cl. 16/254

(57) ABSTRACT

A hinge structure comprises a male hinge and a female hinge. The male hinge comprises a shaft extended along a first extension direction, and at least one hinge cap formed with at least one positioning structure. The female hinge comprises a female hinge connection portion and a socket portion. The socket portion is extended from the female hinge connection portion, hitches the shaft, forms with at least one hole to make the socket portion be flexible along the first extension direction, and comprises at least one positioning member neighboring to the hinge cap. The positioning member positions the male hinge when the shaft rotates to make the positioning structure match to the positioning member. The socket portion is stretched or compressed along the first extension direction when the shaft rotates to make the positioning structure apart from the positioning member.

### FIELD OF THE INVENTION

The present invention relates to a hinge structure, and more particularly to a hinge structure with a flexible socket portion.

### BACKGROUND OF THE INVENTION

In daily life, a hinge structure is usually assembled between two objects to make a foldable object, comprises the two objects, be capable of lifting-opened and closing. An existed hinge structure usually comprises a male hinge and a female hinge. The male hinge comprises a connection portion and a shaft, and the female hinge usually comprises another connection portion and a socket portion. In general, the shaft of the male hinge is rotatably assembled into the socket portion of the female hinge, the connection portion of the male is connected to a first object, and the connection portion of the female hinge is connected to a second object. Therefore, the first object can rotate by a center of the shaft to make the first object be capable of lifting-opened from the second object, or be capable of closing to the second object, so as to form the foldable object as mentioned.

In practice, for making the male hinge can be respectively positioned and locked with the female hinge, at least one positioning mechanism is usually formed between the male hinge and the female hinge. Among all the relative technologies, the positioning technologies well known by people are assembled with flexible plates, hookers, tenons, positioning pins, etc., so as to generate elastic deformation or dimensional interference to provide the performance of positioning. Due to that the relative technologies have been well known by the most people, it is unnecessary to provide further description for them.

However, in the most positioning technologies of the hinge structures as mentioned above, it is usually necessary to additionally manufacture a couple of positioning mechanisms respectively fitted on the male hinge and the female hinge to provided the function of positioning and locking under the whole rotation process. Due to that the positioning mechanisms are not respectively formed in an integral part with the male hinge and the female hinge, it is usually to additionally do an additionally manufacturing procedure of assembling the positioning mechanisms respectively to the male hinge and the female hinge, so as to increase the cost of manufacturing.

Even more, in some positioning technologies as known by the most people, at least one couple of the positioning mechanisms, are respectively formed in an integral part with the male hinge and the female. However, due to that the male hinge and female hinge are rigid bodies, when performing the positioning function, the positioning mechanisms themselves needs to deform elastically to absorb more distortion energy for the elastic deformation or the dimensional interference as mentioned. Therefore the wear and the elastic fatigue of the positioning mechanisms will shorten the usage life of the hinge structure.

### SUMMARY OF THE INVENTION

Due to that in the prior arts, there are two main problems of increasing the cost manufacturing, and shortening the usage life of the hinge structure, the primary object of the present invention provides an improved hinge structure to solve the problems. In the present invention, a positioning member is formed in an integral part with the female hinge, and the female hinge itself is provided with flexibility to assist in absorbing the distortion energy as mentioned, so as to save the cost of manufacturing and extending the usage life of the hinge structure.

Means of the present invention for solving the problems as mentioned above provides a hinge structure comprising a male hinge and a female hinge. The male hinge comprises a male hinge connection portion, a shaft extended along a first extension direction from the male hinge connection portion, and at least one hinge cap connected to the shaft, wherein the hinge cap is formed with at least one positioning structure. The female hinge comprises a female hinge connection portion and a socket portion. The socket portion is extended from the female hinge connection portion, hitches the shaft, forms with at least one hole to make the socket portion be flexible along the first extension direction, and comprises at least one positioning member neighboring to the hinge cap.

The positioning member positions the male hinge when the shaft rotates to make the positioning structure match to the positioning member. The socket portion is stretched or compressed along the first extension direction when the shaft rotates to make the positioning structure apart from the positioning member.

In the preferred embodiments of the present invention, a punched plate is applied to manufacture the female hinge. The punched plate comprises the female hinge connection portion and an extension plate extended from the female hinge connection portion. The extension plate comprises at least one protrusion, so as to from the positioning member of the socket portion when the extension plate is rolled to make the socket portion. The extension plate is further formed with at least one concave edge or punched hole, so as to from the hole of the socket portion when the extension plate is rolled to make the socket portion.

From above description, comparing with the technology as disclosed in prior arts, in the present invention, the protrusion, the concave edge and the punched hole are naturally formed one the punched plate when punching and/or forging the punched plate. Therefore, the positioning member will also be naturally formed when the extension plate of the punched plate is rolled to make the socket portion. It is obvious that through the technology of the present invention, it is unnecessary to do any additional manufacturing procedure of assembling the positioning mechanisms, such as the positioning structure and the positioning member, so as to saving the cost of manufacturing the hinge structure.

Furthermore, due to that the socket portion itself is flexible along the first extension direction, when the shaft rotates with respect to the socket portion to make the positioning structure apart from the positioning member, the socket portion itself can be stretched or compressed along the first extension direction to absorb the distortion energy as mentioned to reduce the destruction of the wear and the flexible fatigue of the positioning mechanisms.

The devices, characteristics, and the preferred embodiment of this invention are described with relative figures as follows.

### BRIEF DESCRIPTION OF THE DRAWINGS

The structure and the technical means adopted by the present invention to achieve the above and other objects can be best understood by referring to the following detailed description of the preferred embodiments and the accompanying drawings, wherein

FIG. 1 illustrates an exploded view of a first embodiment of the present invention;

FIG. 2 illustrates the first embodiment of the present invention after assembling all components;

FIG. 3 illustrates that a punched plate is applied to manufacture the female hinge in the first embodiment of the present invention;

FIG. 4 illustrates an exploded view of a second embodiment of the present invention;

FIG. 5 illustrates another punched plate being applied to manufacture the female hinge in the second embodiment of the present invention;

FIG. 6 illustrates an exploded view of a third embodiment of the present invention;

FIG. 7 illustrates that another punched plate is applied to manufacture the female hinge in the third embodiment of the present invention;

FIG. 8 illustrates an exploded view of a fourth embodiment of the present invention;

FIG. 9 illustrates that another punched plate is applied to manufacture the female hinge in the fourth embodiment of the present invention;

FIG. 10 illustrates an exploded view of a fifth embodiment of the present invention; and

FIG. 11 illustrates that another punched plate is applied to manufacture the female hinge in the fifth embodiment of the present invention.

### DETAILED DESCRIPTION OF THE PREFERRED EMBODIMENTS

The hinge structure as provided in accordance with the present invention can widely use to manufacture many kinds of foldable objects, the combined applications are too numerous to be enumerated and described, so that only five preferred embodiments are disclosed as follows for representation.

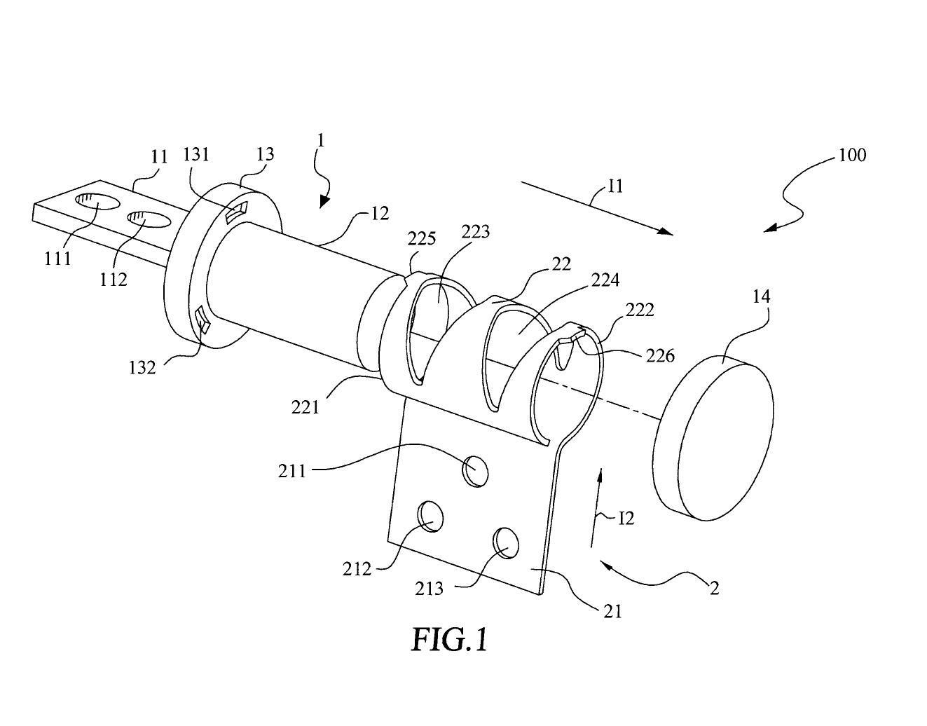

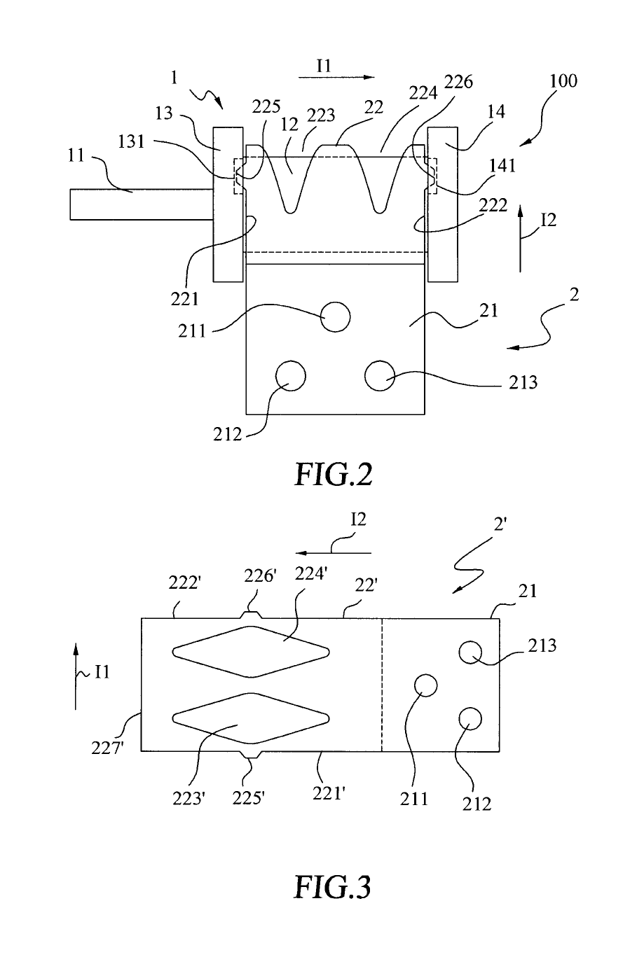

Please refer to FIG. 1 to FIG. 3, wherein FIG. 1 illustrates an exploded view of a first embodiment of the present invention; FIG. 2 illustrates the first embodiment of the present invention after assembling all components; and FIG. 3 illustrates that a punched plate is applied to manufacture the female hinge in the first embodiment of the present invention. As shown in the figures, a hinge structure 100 comprises a male hinge 1 and a female hinge 2. The male hinge 1 comprises a male hinge connection portion 11, a shaft 12, two hinge caps 13 and 14. The male hinge connection portion 11 is formed with two connection holes 111 and 112 for connecting to a first object (not shown). The shaft 12 is extended along a first extension direction I1 form the male hinge connection portion 11. The hinge caps 13 and 14 are respectively connected to two ends of the shaft 12.

Two positioning structures 131 and 132 are formed on the hinge cap 13, and facing to the hinge cap 14. Similarly, two positioning structures are formed on the hinge cap 14, and facing to the hinge cap 13. In FIG. 2, only one of the two positioning structures formed on the hinge caps 14 is marked with the element number 141. In the first embodiment of the present invention, the positioning structures 131, 132 and 141 are positioning grooves recessed from the surface of the hinge cap 13 or 14; however, in practice applications, they also can be positioning protrusions protruded form the surface of the hinge cap 13 or 14.

The female hinge 2 comprises a female hinge connection portion 21 and a socket portion 22, the female hinge connection portion 21 formed with connection holes 211, 212 and 213 for connecting to a second object (not shown). The socket portion 22 is extended from the female hinge connection portion 21, and also extended along the first extension direction I1 from a first end surface 221 to the second end surface 222, and hitches the shaft 12. The socket portion 22 is formed with two (close type) holes 223 and 224, so as to make the socket portion 22 be flexible along the first extension direction I1. The socket portion 22 further comprises two positioning members 225 and 226. The positioning member 225 neighbors to the hinge cap 13, and protrudes along a direction opposite to the first extension direction I1 from the first end surface 221 toward the hinge cap 13. Similarly, the positioning member 226 neighbors to the hinge cap 14, and protrudes along the first extension direction I1 from the second end surface 222 toward the hinge cap 14. In the first embodiment of the present invention, due to that he positioning structures 131, 132 and 141 are recessed positioning grooves, the positioning members 225 and 226 are protruded positioning protrusions. However, if the positioning structures 131, 132 and 141 were protruded positioning protrusions, the positioning members 225 and 226 should be recessed positioning grooves.

When the shaft 12 rotates with respect to the socket portion 22. The hinge cap 13 and 14 are simultaneously rotates with respect to the socket portion 22. When the positioning structure 131 or 132 of the hinge cap 13 is located in a location matching to the positioning member 225, the socket portion can stretch along a direction opposite to the first extension direction I1 to make the positioning member 225 be fitted to the positioning structure 131 or 132, so that the positioning member can position the male hinge 1. In this moment, if the shaft 12 goes on rotating with respect to the socket portion 22, the socket portion 22 will be compressed along the first extension direction I1 to make the positioning structure 131 or 132 be apart from the positioning member 225.

In the first embodiment of the present, the female hinge 2 is made by rolling a punched plate 2′ comprising the female hinge connection portion 21 and a extension plate 22′, wherein the extension plate 22′ is rolled to make the socket portion 22. The extension plate 22′ is extended along a second extension direction 12 from the female hinge connection portion 21 to a side end 227′. The extension plate 22′ is also extended along the first extension direction I1 form a first end portion 221′ to a second end portion 222′. The first extension direction I1 is vertical to the second extension direction 12.

The extension plate 22′ is formed with two punched holes 223′ and 224′. The extension plate 22′ is further formed with two protrusions 225′ and 226′. The protrusion 225′ is protruded along a direction opposite to the first extension direction I1 from the first end portion 221′. The protrusion 226′ is protruded along the first extension direction I1 from the second end portion 222′. When the extension plate 22′ is rolled to make the socket portion 22, the punched holes 223′ and 224′ can respectively from the holes 223 and 224 as mentioned, and the protrusion 225′ and 226′ can respectively from the positioning members 225 and 226 as mentioned.

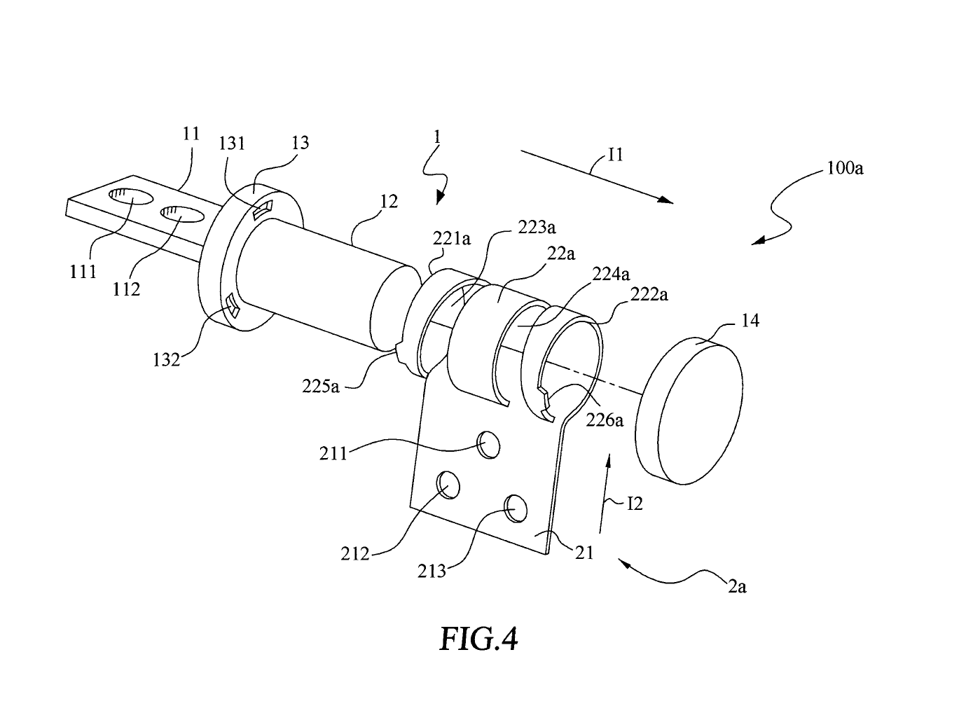

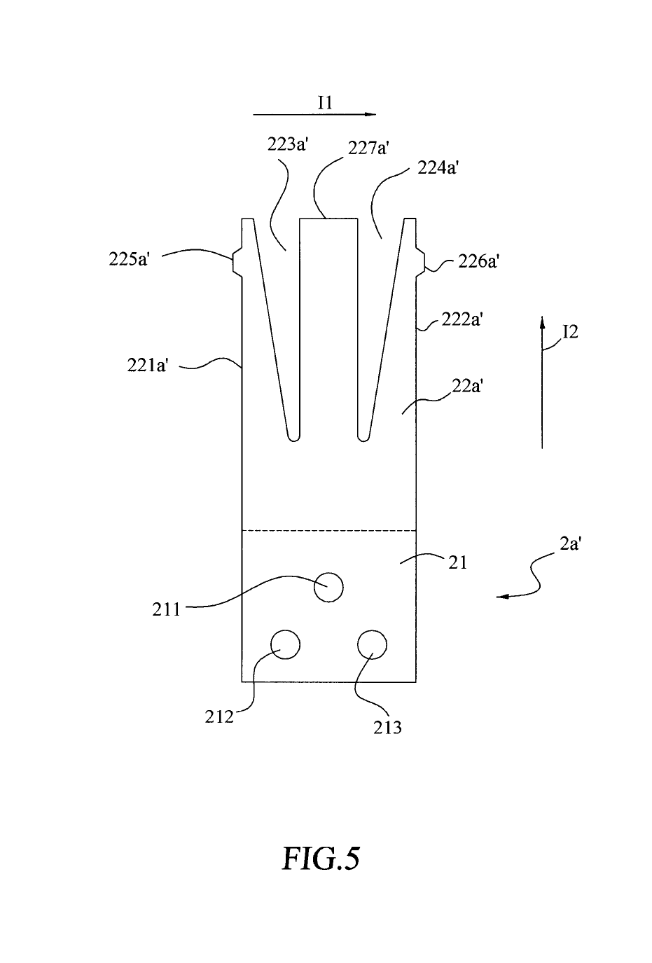

Please go on referring to FIG. 4 and FIG. 5, wherein FIG. 4 illustrates an exploded view of a second embodiment of the present invention; and FIG. 5 illustrates that another punched plate is applied to manufacture the female hinge in the second embodiment of the present invention. As shown in the figures, in the second embodiment of the present invention, another female hinge 2a is applied to replace the female hinge 2 to form another female hinge 100a, wherein another socket portion 22a is applied to replace the socket portion 22. The socket portion 22a is extended from the female hinge connection portion 21, also extended along the first extension direction I1 from a first end surface 221a to a second end surface 222a, and hitches the shaft 12.

The socket portion 22a is formed with two (open type) holes 223a and 224a, so as to make the socket portion 22a be flexible along the first extension direction I1. The socket portion 22a further comprises two positioning member 225a and 226a. The positioning members 225a neighbors to the hinge cap 13, and protrudes along a direction opposite to the first extension direction I1 from the first end surface 221a toward the hinge cap 13. Similarly, the positioning member 226a neighbors to the hinge cap 14, and protrudes along the first extension direction I1 from the second end surface 222a toward the hinge cap 14.

In the second embodiment of the present, the female hinge 2a is made by rolling a punched plate 2a′ comprising the female hinge connection portion 21 and a extension plate 22a′, wherein the extension plate 22a′ is rolled to make the socket portion 22a. The extension plate 22a′ is extended along the second extension direction 12 from the female hinge connection portion 21 to a side end 227a′. The extension plate 22a′ is also extended along the first extension direction I1 form a first end portion 221a′ to a second end portion 222a′.

The extension plate 22a′ is formed with two concave edges 223a′ and 224a′ on the side end 227a′, concaved along a direction opposite to the second extension portion 12. The extension plate 22a′ is further formed with two protrusions 225a′ and 226a′. The protrusion 225a′ is protruded along a direction opposite to the first extension direction I1 from the first end portion 221a′. The protrusion 226a′ is protruded along the first extension direction I1 from the second end portion 222a′. When the extension plate 22a′ is rolled to make the socket portion 22a, the concave edges 223a′ and 224a′ can respectively from the holes 223a and 224a as mentioned, and the protrusion 225a′ and 226a′ can respectively from the positioning members 225a and 226a as mentioned.

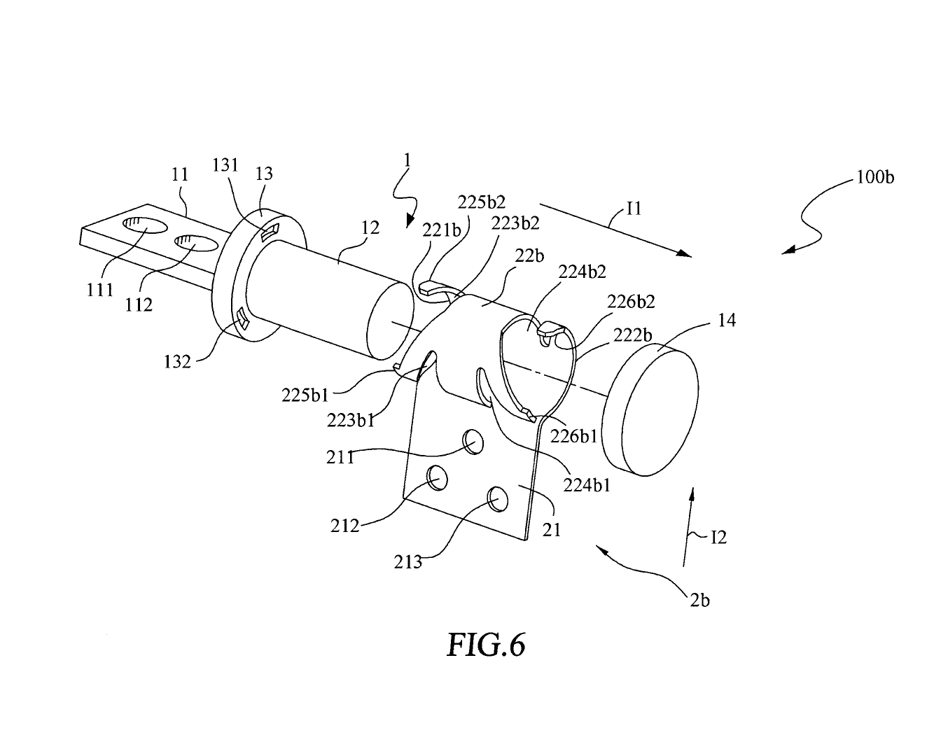

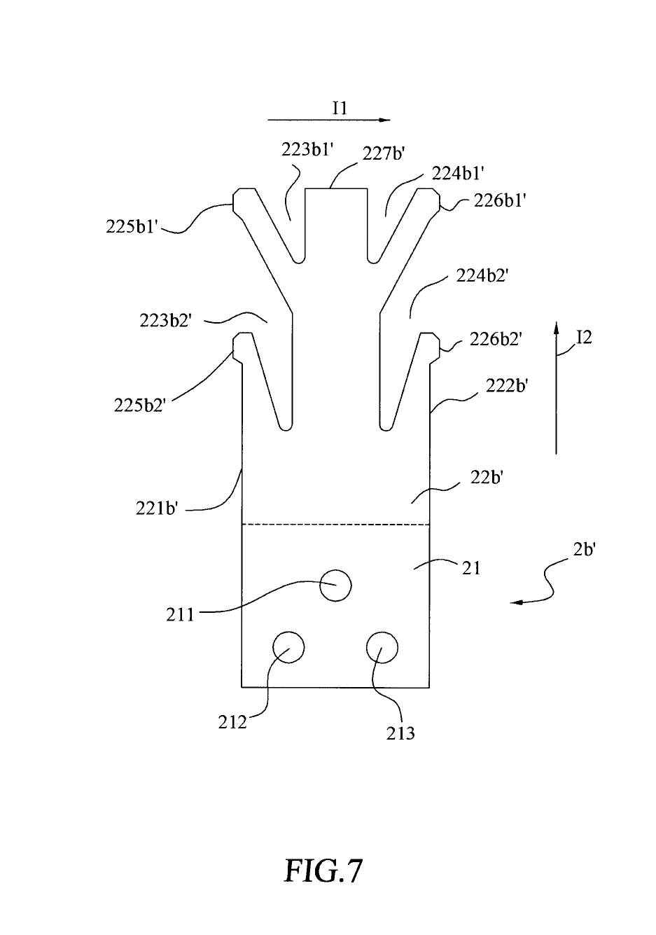

Please go on referring to FIG. 6 and FIG. 7, wherein FIG. 6 illustrates an exploded view of a third embodiment of the present invention; and FIG. 7 illustrates that another punched plate is applied to manufacture the female hinge in the third embodiment of the present invention. As shown in the figures, in the third embodiment of the present invention, another female hinge 2b is applied to replace the female hinge 2 to form another female hinge 100b, wherein another socket portion 22b is applied to replace the socket portion 22. The socket portion 22b is extended from the female hinge connection portion 21, also extended along the first extension direction I1 from a first end surface 221b to a second end surface 222b, and hitches the shaft 12.

The socket portion 22b is formed with four (open type) holes 223b1, 223b2, 224b1 and 224b2, so as to make the socket portion 22b be flexible along the first extension direction I1. The socket portion 22b further comprises four positioning members 225b1, 225b2, 226b1 and 226b2. The positioning members 225b1 and 225b2 neighbor to the hinge cap 13, and protrude along a direction opposite to the first extension direction I1 from the first end surface 221b toward the hinge cap 13. Similarly, the positioning members 226b1 and 226b2 neighbor to the hinge cap 14, and protrude from along the first extension direction I1 the second end surface 222b toward the hinge cap 14.

In the third embodiment of the present, the female hinge 2b is made by rolling a punched plate 2b′ comprising the female hinge connection portion 21 and a extension plate 22b′, wherein the extension plate 22b′ is rolled to make the socket portion 22b. The extension plate 22b′ is extended along the second extension direction 12 from the female hinge connection portion 21 to a side end 227b′. The extension plate 22b′ is also extended along the first extension direction I1 form a first end portion 221b′ to a second end portion 222b′.

The extension plate 22b′ is formed with four concave edges 223b1′, 223b2′, 224b1′ and 224b2′. The concave edges 223b1′ and 224b2′ are concaved from the end side 227b′, along a direction opposite to the second extension portion 12. The concave edge 223b2′ is concaved from first end portion 221b′, and the concave edge 224b2′ is concaved from first end portion 221b′. The extension plate 22b′ is further formed with four protrusions 225b1′, 225b2′, 226b1′ and 226b2′. The protrusions 225b1′ and 225b2′ are protruded along a direction opposite to the first extension direction I1 from the first end portion 221b′. The protrusions 226b1′ and 226b2′ are protruded along the first extension direction I1 from the second end portion 222b′. When the extension plate 22b′ is rolled to make the socket portion 22b, the concave edges 223b1′, 223b2′, 224b1′ and 224b2′ can respectively from the holes 223b1, 223b2, 224b1 and 224b2 as mentioned, and the protrusions 225b1′, 225b2′, 226b1′ and 226b2′ can respectively from the positioning members 225b1, 225b2, 226b1 and 226b2 as mentioned.

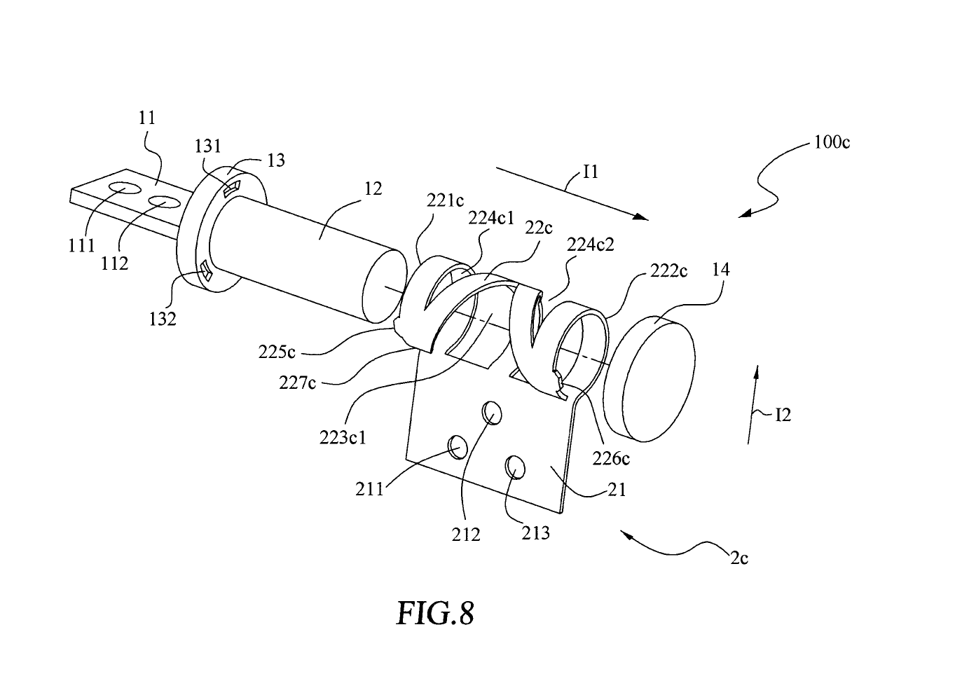

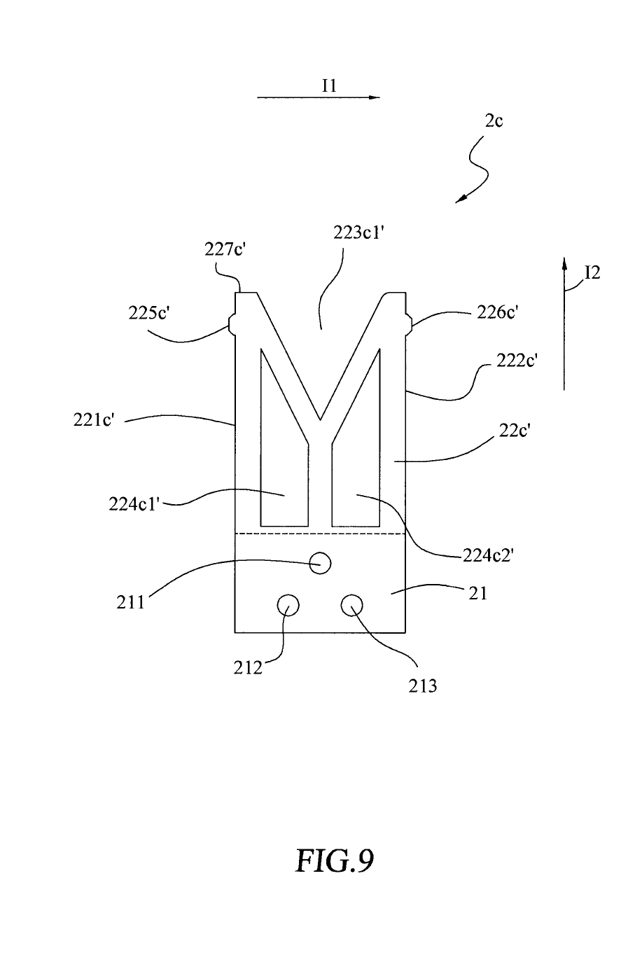

Please go on referring to FIG. 8 and FIG. 9, wherein FIG. 8 illustrates an exploded view of a fourth embodiment of the present invention; and FIG. 9 illustrates that another punched plate is applied to manufacture the female hinge in the fourth embodiment of the present invention. As shown in the figures, in the fourth embodiment of the present invention, another female hinge 2c is applied to replace the female hinge 2 to form another female hinge 100c, wherein another socket portion 22c is applied to replace the socket portion 22. The socket portion 22c is extended from the female hinge connection portion 21, also extended along the first extension direction I1 from a first end surface 221c to a second end surface 222c, and hitches the shaft 12.

The socket portion 22c is formed with a (open type) hole 223c1, and further formed with two (close type) holes 224c1 and 224c2, so as to make the socket portion 22c be flexible along the first extension direction I1. The socket portion 22c further comprises two positioning members 225c and 226c. The positioning member 225c neighbors to the hinge cap 13, and protrudes along a direction opposite to the first extension direction I1 from the first end surface 221c toward the hinge cap 13. Similarly, the positioning member 226c neighbors to the hinge cap 14, and protrudes along the first extension direction I1 from the second end surface 222c toward the hinge cap 14.

In the fourth embodiment of the present, the female hinge 2c is made by rolling a punched plate 2c′ comprising the female hinge connection portion 21 and a extension plate 22c′, wherein the extension plate 22c′ is rolled to make the socket portion 22c. The extension plate 22c′ is extended from the female hinge connection portion 21, along the second extension direction 12, to a side end 227c′. The extension plate 22c′ is also extended form a first end portion 221c′, along the first extension direction I1, to a second end portion 222c′.

The extension plate 22c′ is formed with a concave edge 223c1′ and two punched holes 224c1′ and 224c2, and the concave edge 223c1′ is concaved from the end side 227c′, along a direction opposite to the second extension portion 12. The extension plate 22c′ is further formed with two protrusions 225c′ and 226c′. The protrusion 225c′ is protruded along a direction opposite to the first extension direction I1 from the first end portion 221c′. The protrusion 226c′ is protruded along the first extension direction I1 from the second end portion 222c′. When the extension plate 22c′ is rolled to make the socket portion 22c, the concave edge 223c1′ and the punched holes 224c′ and 224c′ can respectively from the holes 223c1, 224c1 and 224c2 as mentioned, and the protrusions 225c′ and 226c′ can respectively from the positioning members 225c and 226c as mentioned.

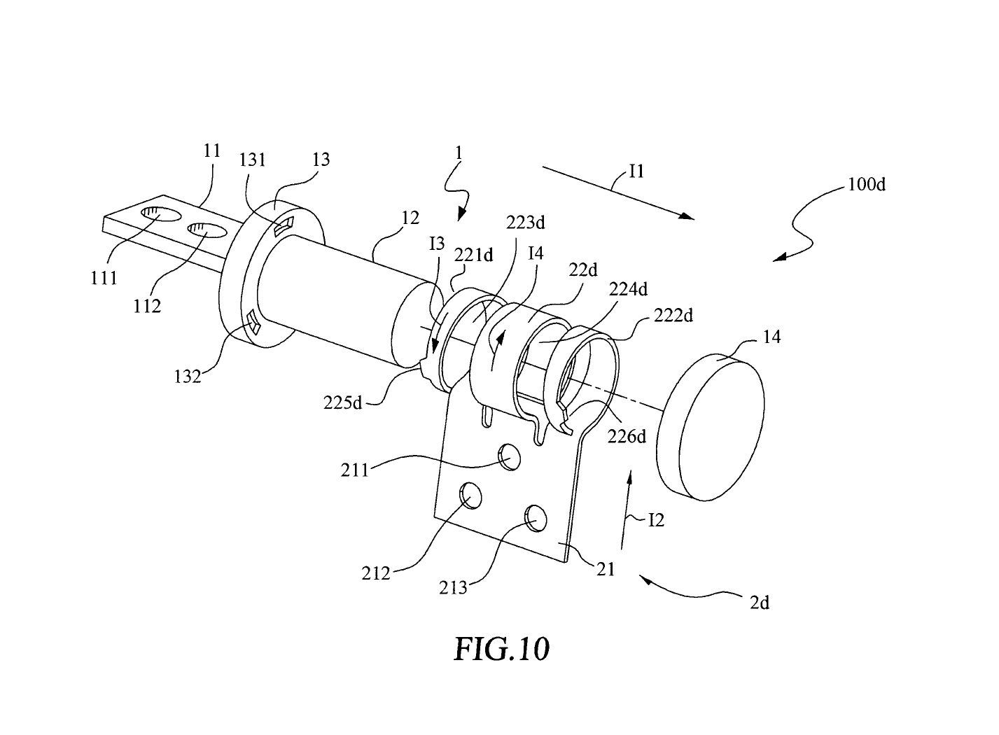

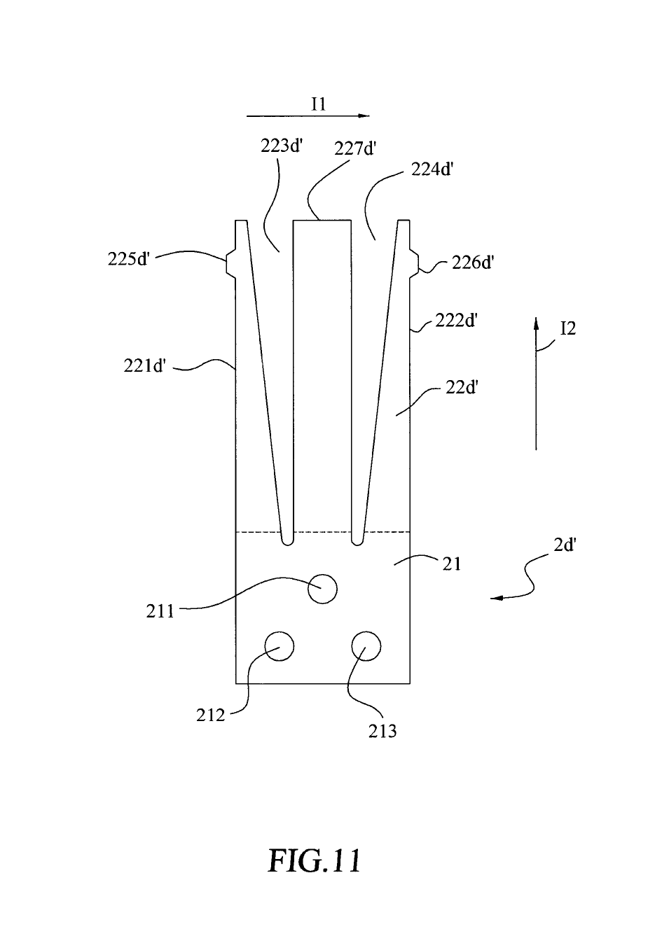

Please go on referring to FIG. 10 and FIG. 11, wherein FIG. 10 illustrates an exploded view of a fifth embodiment of the present invention; and FIG. 10 illustrates that another punched plate is applied to manufacture the female hinge in the fifth embodiment of the present invention. As shown in the figures, in the fifth embodiment of the present invention, another female hinge 2d is applied to replace the female hinge 2 to form another female hinge 100d, wherein another socket portion 22d is applied to replace the socket portion 22. The socket portion 22d is extended from the female hinge connection portion 21, also extended along the first extension direction I1 from a first end surface 221d to a second end surface 222d, and hitches the shaft 12.

The socket portion 22d is formed with two (open type) holes 223d and 224d, so as to make the socket portion 22d be flexible along the first extension direction I1. The socket portion 22d further comprises two positioning members 225d and 226d. The positioning member 225d neighbors to the hinge cap 13, and protrudes along a direction opposite to the first extension direction I1 from the first end surface 221d toward the hinge cap 13. Similarly, the positioning member 226d neighbors to the hinge cap 14, and protrudes along the first extension direction I1 from the second end surface 222d toward the hinge cap 14.

In the fifth embodiment of the present, the female hinge 2d is made by rolling a punched plate 2d′ comprising the female hinge connection portion 21 and a extension plate 22d′, wherein the extension plate 22d′ is rolled to make the socket portion 22d. The extension plate 22d′ is extended along the second extension direction 12 from the female hinge connection portion 21 to a side end 227d′. The extension plate 22d′ is also extended along the first extension direction I1 form a first end portion 221d′ to a second end portion 222d′.

The extension plate 22d′ is formed with two concave edge 223d′ and 224d′ concaved from the end side 227d′, along a direction opposite to the second extension portion 12. Thus, the extension plate 22d′ is divided into a central region and two side regions. The extension plate 22d′ is further formed with two protrusions 225d′ and 226d′. The protrusion 225d′ is protruded along a direction opposite to the first extension direction I1 from the first end portion 221d′. The protrusion 226d′ is protruded along the first extension direction I1 from the second end portion 222d′. When the extension plate 22c′ is rolled to make the socket portion 22c, the two side regions are rolled along a first rolling direction 13, and the central region is rolled along a second rolling direction 14.

After finishing rolling the extension plate 22d′, the concave edge 223d′ and 224d can respectively from the holes 223d and 224d as mentioned, and the protrusions 225c′ and 226c′ can respectively from the positioning members 225c and 226c as mentioned. Therefore, it is obvious that the present invention also can be applied to the conventional female hinge, which multiply hitches the shaft of the male hinge both along two different directions.

People skilled in ordinary art can easily realize that due to that the protrusions, the concave edges and the punched holes are formed when punching and/or forging the extension plate 22′, 22a′, 22b′, 22c′ and 22d′. Therefore, when the extension plate 22′, 22a′, 22b′, 22c′ and 22d′ are respectively rolled to make the socket portion 22, 22a, 22b, 22c and 22d, the positioning members and holes will be naturally formed on the socket portions. It is obvious that it is unnecessary to do the manufacturing procedure of assembling the positioning members, such as the positioning structure and the positioning member.

Furthermore, due to that the socket portions 22, 22a, 22b, 22c and 22d themselves are flexible along the first extension direction, when the shaft 12 rotates with respect to the socket portions 22, 22a, 22b, 22c or 22d to make the positioning structure apart from the positioning member, the socket portions 22, 22a, 22b, 22c or 22d can be stretched or compressed along the first extension direction I1, so as to absorb the distortion energy the reduce the destruction of wear and flexible fatigue of the positioning member. Form above description, it is obvious that the present invention really can effectively extend the usage life of the hinge structure.

Although the present invention has been described with reference to the preferred embodiments thereof, it is apparent to those skilled in the art that a variety of modifications and changes may be made without departing from the scope of the present invention which is intended to be defined by the appended claims.

What is claimed is:

1. A hinge structure, comprising:
a male hinge, comprising:
a shaft extended along a first extension direction;
at least one hinge cap connected to at least one end of the shaft and formed with at least one positioning structure; and
a female hinge, comprising:
a female hinge connection portion; and
a socket portion extended from the female hinge connection portion hitching the shaft, formed with at least one hole to make the socket portion be flexible along the first extension direction, and comprising:
at least one positioning member neighboring to the hinge cap;
wherein the positioning member positions the male hinge when the shaft rotates to make the positioning structure match to the positioning member; and the socket portion is stretched or compressed along the first extension direction when the shaft rotates to make the positioning structure apart from the positioning member.

2. The hinge structure as claimed in claim 1, wherein the socket portion is made by rolling an extension plate, which is extended along a second extension direction from the female hinge connection portion to a side end, and also extended along the first extension direction from a first end portion to the a second end portion.

3. The hinge structure as claimed in claim 2, wherein the first extension direction is vertical to the second extension direction.

4. The hinge structure as claimed in claim 2, wherein at least one protrusion is extended along a direction opposite to the first extension direction from the first end portion, so as to form the positioning member when the extension plate is rolled to make the socket portion.

5. The hinge structure as claimed in claim 2, wherein at least one protrusion is extended along the first extension direction from the second end portion, so as to form the positioning member when the extension plate is rolled to make the socket portion.

6. The hinge structure as claimed in claim 2, wherein at least one concave edge is formed on the side end, so as to form the hole when the extension plate is rolled to make the socket portion.

7. The hinge structure as claimed in claim 6, wherein the concave edge is concaved from the side end, along a direction opposite to the second extension direction.

8. The hinge structure as claimed in claim 2, wherein at least one concave edge is formed on the first end portion, so as to form the hole when the extension plate is rolled to make the socket portion.

9. The hinge structure as claimed in claim 2, wherein at least one concave edge is formed on the second end portion, so as to form the hole when the extension plate is rolled to make the socket portion.

10. The hinge structure as claimed in claim 2, wherein the extension plate further formed with at least one punched hole, so as to form the hole when the extension plate is rolled to make the socket portion.

11. The hinge structure as claimed in claim 1, wherein the positioning structure is a positioning groove.

12. The hinge structure as claimed in claim 11, wherein the positioning member is a positioning protrusion.

13. The hinge structure as claimed in claim 1, wherein the positioning structure is a positioning protrusion.

14. The hinge structure as claimed in claim 13, wherein the positioning member is a positioning groove.

15. The hinge structure as claimed in claim 1, wherein the female hinge connection portion further formed with at least one connection hole.

16. The hinge structure as claimed in claim 1, wherein the male hinge further comprises a male hinge connection portion, and the shaft is extend extended along the first extension direction from the male hinge connection portion.

17. The hinge structure as claimed in claim 1, wherein the male hinge connection portion is formed with at least one connection portion.
